(19) United States
(12) Patent Application Publication
(10) Pub. No.: US 2007/0037698 A1
(43) Pub. Date: Feb. 15, 2007

(54) Sol-gel-based methodology for the preparation of oxidation/reduction catalysts

(75) Inventors: Anthony Neal Watkins, Hampton, VA (US); Jacqueline L. Schryer, Hampton, VA (US); Jerry C. Summers, Charleston, WV (US); Jeffrey D. Jordan, Lockport, NY (US); Bradley D. Leighty, Gloucester, VA (US); Patricia P. Davis, Yorktown, VA (US)

Correspondence Address: GEORGE F. HELFRICH, 162 SHASTA DRIVE, NEWPORT NEWS, VA, 23608, US

(73) Assignees: Science and Technology Corp.; United States of America (NASA)

(21) Appl. No.: 11/203,518

(22) Filed: Aug. 12, 2005

(51) Int. Cl. B01J 21/00

(52) U.S. Cl. 502/263; 502/325; 502/326; 502/327; 502/332; 502/333; 502/334; 502/339

(57) ABSTRACT

A process for preparing an oxidation/reduction catalyst system includes providing a sol-gel precursor; providing a metal oxide wash coat mixture; and dispersing the sol-gel precursor in the metal oxide wash coat mixture to provide a dispersion of sol-gel precursor in metal oxide wash coat mixture. This dispersion of sol-gel precursor in metal oxide wash coat mixture is then deposited on a support, which is subsequently thermally-treated in an oxygen-containing environment to drive off volatiles and oxidize metallic components, thereby producing a thermally-treated support. Finally, a noble metal coating is applied to the thermally-treated support.

### ORIGIN OF THE INVENTION

This invention was made jointly in the performance of work under a NASA contract and by employees of the United States Government. It is subject to the provisions of Public Law 96-517 (35 USC 202), and may be manufactured and used by or for the Government for governmental purposes without the payment of any royalties thereon or therefor.

### BACKGROUND OF THE INVENTION

1. Field of the Invention

This invention relates generally to oxidation/reduction catalyst systems. It relates particularly to the production of oxidation reduction catalysts employing sol-gel-based methodology.

2. Description of the Related Art

Technology employing oxidation/reduction catalysts has experienced few significant breakthroughs over the past 25 years. For example, automotive catalytic converter technology has changed little since its inception when automotive emission regulations were first implemented. Current catalyst coatings typically consist of a series of aluminum oxide wash coat and precious metal layers baked on the honeycomb channels of a ceramic substrate. The thick catalyst coating comprises about 30% of the total weight of the substrate. These coated “bricks” are then assembled and sealed inside a stainless steel container to allow coupling to an automotive exhaust manifold. As EPA emission regulations have tightened, the industry response has been to increase the size of the bricks, to add more weight of precious metal, and to move the catalytic converter into closer proximity with the engine, increasing exhaust temperatures for improvement in catalytic activity. The results of these changes have been increasing costs for catalytic converters, as well as decreased automobile fuel efficiency.

In response to the obvious, long-felt need for a new generation of catalysts (e.g., for automotive applications), the National Aeronautics and Space Administration and its contractors have developed an effective low-temperature oxidation/reduction catalyst. Reference is made in particular to the following U.S. Pat. Nos.: 4,912,082; 4,991,181; 4,855,274; 4,829,035; 4,839,330; 5,585,083; and 6,132,694.

The primary object of the present invention is to significantly improve the performance characteristics of oxidation/reduction catalysts, especially the new generation of low-temperature catalysts referred to above, by: (1) enhancing the adherence of metal oxide based active layers; (2) increasing total active catalytic surface area; (3) extending catalyst durability by enhancing temperature stability; and (4) providing a simple method of producing active catalyst based particle supports directly.

### SUMMARY OF THE INVENTION

The present invention, which employs sol-gel-based methodology, serves to significantly enhance catalytic performance, efficiency, and durability by increasing catalyst adherence, enhancing surface area, and improving high-temperature stability. The techniques disclosed herein are employed not only to augment application of existing catalyst formulations onto substrate materials, but also to produce catalytic-based substrate materials directly.

In conventional modes of catalyst preparation, multiple layers of inactive support (e.g., alumina) are applied to a substrate material (e.g., cordierite or silica gel) by successive wash coating of a slurry of particles dispersed in a solvent (e.g., alcohol). The mechanism for adherence is simple adsorption of material, relying heavily on the predilection of smaller particles to penetrate and adsorb onto the porous regions of the substrate to form an anchor for subsequent layers.

In the present invention, a sol-gel solution as the liquid phase in a slurry wash coat solution readily penetrates porous cracks and fissures in the substrate material and the particles themselves, chemically bonding to the surface thereof by means of a condensation mechanism involving surface hydroxyl groups.

The instant sol-gel-based approach to the preparation of oxidation/reduction catalysts positively affects three primary applications: (1) catalytic converters for internal combustion/automotive applications; (2) air purification/HVAC systems; and (3) gas phase sensing systems.

### DETAILED DESCRIPTION OF THE INVENTION

The present invention is a process for producing an oxidation/reduction catalyst system. The process includes the following sequential procedural steps:

(a) providing a sol-gel precursor;

(b) providing a metal oxide wash coat mixture;

(c) dispersing the sol-gel precursor in the metal oxide wash coat mixture to provide a dispersion of sol-gel precursor in metal oxide wash coat mixture;

(d) depositing the dispersion on a support;

(e) thermally treating the support on which the dispersion has been deposited in an oxygen-containing environment to drive off volatiles and oxidize metallic components, producing a thermally-treated support; and

(f) applying a noble metal coating to the thermally-treated support.

Beneficial results are obtained if the sol-gel precursor is an alkoxide, such as a metal or semi-metal alkoxide, which is admixed with a solvent, particularly a member selected from the group consisting of alcohols and ketones. Semi-metal alkoxides, such as alkoxides of aluminum, zirconium, silicon, cerium, and lanthanum, have been employed advantageously. Particularly beneficial results are achieved in the practice of the present invention if the metal or semi-metal alkoxide is a hydrolyzed tetraethoxysilane or an isopropoxy aluminum alkoxide, and the solvent is ethanol.

In the process of the present invention, the metal oxide wash coat mixture is advantageously a solution of an organometallic compound which contains a multivalent metal in an unelevated valence state, the multivalent metal being capable of forming a metal oxide having more than one oxidation state.

In carrying out the process of the present invention, it has been found to be very beneficial if the dispersion of sol-gel precursor in metal oxide wash coat mixture in procedural step (c) above is a solution or a slurry, and the support in procedural step (d) above is a substrate. Acceptable substrates are cordierite, mullite, zerolite, alumina and magnesium aluminate.

Equally beneficial results are obtained if the support in procedural step (d) above is a particulate support, in particular silica, alumina, titania, magnesium oxide, or zinc aluminate.

In the present process, the noble metal employed in step (f) above is advantageously one or more of platinum, palladium, rhodium, ruthenium, iridium, osmium, and rhenium; and the noble metal coating is advantageously applied to the thermally-treated support in step (f) above by sputter coating, as is well-known in the art.

Especially beneficial results are obtained when the noble metal coating is applied to the thermally-treated support in step (f) above by first applying a solution of a noble metal salt to the thermally-treated support of step (e) above to produce a noble metal salt solution-coated support. The noble metal salt solution-coated support is then thermally-treated to drive off volatiles and produce a thermally-treated noble metal salt-coated support, which is subsequently heated in an atmosphere containing a reducing gas to reduce the noble metal salt to noble metal, thereby producing a noble metal coating on the thermally-treated support. Highly efficacious is the employment of carbon monoxide as the reducing gas. In a specially preferred embodiment, the noble metal coating is applied to the thermally-treated support in an amount sufficient to provide a layer of noble metal having a thickness between about 1 μ and about 10 μ.

In another preferred embodiment, the oxygen-containing environment of step (e) above contains oxygen in admixture with one or more of nitrogen, helium, argon, steam, and carbon dioxide, the oxygen being present in an amount sufficient to provide from about 1 percent to about 20 percent by weight of the oxygen-containing environment.

Very beneficial results are obtained in the practice of the present process if the support on which the dispersion is deposited in step (d) above is thermally treated in step (e) above at a temperature between about 100° C. and about 400° C. Furthermore, a highly preferred embodiment includes applying a promoter metal such as iron, nickel, cobalt, manganese, and copper, to the thermally-treated support produced by step (e) above before the noble metal coating is applied thereto in step (f).

The following Example presents detail concerning an exemplary process according to the present invention. It is not intended to limit the scope of the present invention, which is defined by the hereto-appended claims.

SnO₂ coating, first dip. 147.705 g of tin (II) ethylhexanoate and 473 mL (a one pint bottle) of ethanol were mixed in a 600 polyproprylene beaker and covered with a watch glass. Then 109.49 g Silbond H-5® and 473 mL of ethanol were mixed in another 600 mL polypropylene beaker. The contents of the two beakers were combined in a Gladware® 1.89L, deep dish container. As quickly as possible, one monolith was placed into the container, channels oriented vertically, and deaerated. The monolith was removed from the solution, shaken, turned over and re-dipped in the solution before placing in the hood. The samples were not shaken enough to dislodge all excess solution, but were shaken gently and set onto two cordierite rods spaced so that excess solution could drip out of the monolith. The process was repeated with the second monolith. The monoliths were left overnight to drain and to allow the ethanol to evaporate, and were then placed into a ambient temperature furnace (Thermolyene). The temperature program was as follows: ambient to 160° C. ramped at 1° C. per minute, hold two hours; 160-210° C. ramped at 1° C. per minute, hold six hours; 210-300° C. ramped at 1° C. per minute, hold six hours; cooled to room temperature in the oven.

The next day when the samples were removed from the oven it was observed that some crumbling had occurred. Therefore the samples were blown out with compressed air before weighing. As the weight gain due to the disposition of SnO₂ and SiO₂ was less than desired, it was decided that the dipping process would be repeated until sufficient SnO₂/SiO₂ had been deposited. Since sample A-18, our designated benchmark, had a tin loading of about 10.2%, it was decided that we would try for about the same loading. This result was approximated after four dips.

Results of the tin (II) ethylhexanoate/Silbond® dips are found in the following Table I.

TABLE I

| | A-26-a | A-26-b |
|---|---|---|
| Start weight, g | 196.0533 | 197.0568 |
| W after first dip, g | 200.7891 | 200.3138 |
| Incremental W gain, g | 4.7358 | 3.257 |
| Total W gain, % | 2.41557 | 1.65282 |
| W after second dip, g | 205.0556 | 204.7229 |
| Incremental W gain, g | 4.2665 | 4.4091 |
| Total W gain, % | 4.59176 | 3.8903 |
| W after third dip, g | 209.8251 | 208.3209 |
| Incremental W gain, g | 4.7695 | 3.598 |
| Total W gain, % | 7.02452 | 5.71617 |
| W after fourth dip, g | 214.5117 | 212.7347 |
| Incremental W gain, g | 4.6866 | 4.4138 |
| Total W gain, % | 9.41499 | 7.95603 |

Promoter coating. Each promoter nitrate as indicated in the following table (Fe, CO, and Ni) was weighed into a 1 L beaker and then dissolved in distilled H₂O to a final solution volume of 1 L.

Each SnO₂-coated sample was deaerated in the solution, shaken, weighed to determine solution uptake, and then placed into the muffle furnace. The nitrate coatings were thermally decomposed in the Thermolyne muffle furnace using the following temperature program: (1) ambient to 110° C. at 1° C. per minute, hold six hours; (2) 110-550° C. at 10° C. per minute, hold one hour. The samples were then allowed to cool to room temperature in the muffle furnace before weighing.

Actual amounts of promoter compounds used to prepare a 1 L solution are shown in the following Table II.

TABLE II

| Promoter | Weight req'd, g | Weight used, g | Concentration, g/mL |
|---|---|---|---|
| Fe(NO₃)₃*9H₂0 | 80.6 | 80.66 | 0.0733 |
| Co(NO₃)₂*6H₂0 | 58.0 | 58.036 | 0.0528 |
| Ni(NO₃)₂*6H₂0 | 58.0 | 58.085 | 0.0528 |

Fe, Co, and Ni loading data are shown in the following Table III.

TABLE III

Sample

| | A-26-a | A-26-b |
|---|---|---|
| W_{cord}, g | 196.0533 | 197.0568 |
| W_{f}_{_{—}}_{SnO2/SiO2}, g | 214.5117 | 212.7347 |
| W_{SnO2/SiO2}, g | 18.46 | 15.6779 |
| % Sn02 + SiO2/total | 8.6049 | 7.3697 |
| % Sn02 + SiO2/cord | 9.415 | 7.956 |
| W_{wet}, g | 263.9929 | 265.4621 |
| ΔW_{sol'n}, g | 49.4812 | 52.7274 |
| V prom, sol'n, mL | 44.18 | 47.08 |
| W_{dry}, g (550 C) | 216.9006 | 215.3131 |
| W_{Fe2O3}, g | 0.640 | 0.682 |
| W_{Co3O4}, g | 0.643 | 0.686 |
| W_{NiO}, g | 0.599 | 0.639 |
| Wₚᵣₒₘ, g | 1.883 | 2.006 |
| % prom/SnO₂ | 9.26 | 11.34 |

Sample calculation for W_{Prom} for Sample A-26-a.

$${W}_{Fe 2 O 3} = 44.18 mL * \frac{0.0733 g}{mL} * \frac{159.69 - mol {Fe}_{2} {O}_{3}}{2 * 404 g - mol Fe - nitr} = 0.640 g {Fe}_{2} {O}_{3}$$

$${W}_{Co 3 O 4} = 44.18 mL * \frac{0.0528 g}{mL} * \frac{240.80 - mol {Co}_{3} {O}_{4}}{3 * 291.04 g - mol Co - nitr} = 0.643 g {Co}_{3} {O}_{4}$$

$${W}_{NiO} = 44.18 mL * \frac{0.0528 g}{mL} * \frac{74.71 g - mol NiO}{290.81 g - mol Ni - nitr} = 0.597 g NiO$$

$${W}_{Prom} = {W}_{Fe 2 O 3} + {W}_{Co 3 O 3} + {W}_{NiO} = 1.88 g$$

Pt and Ru loading using H₂PtCl₆ and RuCl₃: A total metal loading of 0.02 g/in³ of cordierite was deposited on these samples with 50% of the weight of each Pt and Ru.

The amount of each Ru and Pt required to achieve this loading on the monoliths is 54 in³*0.01 g/in³=0.54 g of each metal. Therefore, the weight of H₂PtCl₆ required is

$$0.54 g Pt * [ \frac{1 g {H}_{2} {PtCl}_{6}}{0.3934 g Pt} ] = 1.3726 g {H}_{2} {PtCl}_{6}$$

According to the manufacturer, the weight percentage of Ru in RuCl₃ is 35-40%. To ensure that at least 0.005 g Ru/in³ is achieved, the minimum assay is used in the calculation of the quantity required. In order to have equal weights of each metal, the weight of RuCl₃ required is

$$0.54 g Ru * [ \frac{1 g {RuCl}_{3}}{0.35 g Ru} ] = 15429 g {RuCl}_{3}$$

The noble metal solution was prepared in a 250 mL polypropylene beaker by dissolving 1.5434 of RuCl₃ and 1.3765 g of H₂PtCl₆in 20 mL (15.84 g) ethanol and then adding 75 mL of distilled H₂O. The resulting concentrations of RuCl₃ and H₂PtCl₆ were

$$[ {RuCl}_{3} ] = \frac{1.5434 g}{1.5434 g + 1.3765 g + 15.84 g + 75 g} = 0.0165 \frac{g {RuCl}_{3}}{g total {sol}^{′} n} \\ [ {H}_{2} {PtCl}_{6} ] = \frac{1.3765 g}{1.5434 g + 1.3765 g + 15.84 g + 75 g} = 0.0147 \frac{g {H}_{2} {PtCl}_{6}}{g total {sol}^{′} n}$$

One quarter of the total volume was added dropwise onto each side of each piece using a plastic syringe pipet and then weighed to determine solution uptake. The samples were then placed in the Thermolyne oven and thermally treated as follows: ambient to 110° C. at 1° C. per minute and held for six hours then ramped to 550° C. at 10° C. per minute and held for one hour before cooling in oven to ambient and weighing.

Reductive treatment. The reductive treatment was a four to six hour reductive treatment under about 250 sccm of 10% CO in at 125° C.

1. A process for preparing an oxidation/reduction catalyst system, which process comprises:
(a) providing a sol-gel precursor;
(b) providing a metal oxide wash coat mixture;
(c) dispersing the sol-gel precursor in the metal oxide wash coat mixture to provide a dispersion of sol-gel precursor in metal oxide wash coat mixture;
(d) depositing the dispersion on a support;
(e) thermally treating the support on which the dispersion has been deposited in an oxygen-containing environment to drive off volatiles and oxidize metallic components, producing a thermally-treated support and;
(f) applying a noble metal coating to the thermally treated support.

2. The process of claim 1, wherein the sol-gel precursor is an alkoxide admixed with a solvent.

3. The process of claim 2, wherein the alkoxide is a metal or semi-metal alkoxide, and the solvent is a member selected from the group consisting of alcohols and ketones.

4. The process of claim 3, wherein the metal or semi-metal alkoxide is a member selected from the group consisting of alkoxides of aluminum, zirconium, silicon, cerium and lanthanum.

5. The process of claim 4, wherein the metal or semi-metal alkoxide is a hydrolyzed tetraethoxysilane or an isopropoxy aluminum alkoxide, and the solvent is ethanol.

6. The process of claim 1, wherein the metal oxide wash coat mixture comprises a solution of an organometallic compound which comprises a multivalent metal in an unelevated valence state, the multivalent metal being capable of forming a metal oxide possessing more than one stable oxidation state.

7. The process of claim 1, wherein the dispersion of sol-gel precursor in metal oxide wash coat mixture in step (c) is a member selected from the group consisting of solutions and slurries.

8. The process of claim 1, wherein the support in step (d) is a substrate.

9. The process of claim 8, wherein the substrate is a member selected from the group consisting of cordierite, mullite, zeolite, alumina and magnesium aluminate.

10. The process of claim 1, wherein the support in step (d) is a particulate support.

11. The process of claim 10, wherein the particulate support is a member selected from the group consisting of silica, alumina, titania, magnesium oxide, and zinc aluminate.

12. The process of claim 1, wherein the noble metal is a member selected from the group consisting of platinum, palladium, rhodium, ruthenium, iridium, osmium, and rhenium.

13. The process of claim 1, wherein the noble metal coating is applied to the thermally-treated support in step (f) by sputter coating.

14. The process of claim 1, wherein the noble metal coating is applied to the thermally-treated support in step (f) by first applying a solution of a noble metal salt to the thermally-treated support to produce a noble metal salt solution-coated support; thermally treating the noble metal salt solution-coated support to drive off volatiles and produce a thermally-treated noble metal salt-coated support, and heating the thermally-treated noble metal salt-coated support in an atmosphere containing a reducing gas to reduce the noble metal salt to noble metal and produce a noble metal coating on the thermally-treated support.

15. The process of claim 14, wherein the reducing gas is carbon monoxide.

16. The process of claim 14, wherein the noble metal coating is applied to the thermally-treated support in an amount sufficient to provide a layer of noble metal having a thickness between about 1 μ and about 10 μ.

17. The process of claim 1, wherein the oxygen-containing environment of step (e) comprises oxygen in admixture with a member selected from the group consisting of nitrogen, helium, argon, steam, and carbon dioxide, the oxygen being present in an amount sufficient to provide from about 1 percent to about 20 percent by weight of the oxygen-containing environment.

18. The process of claim 1, wherein the support on which the dispersion has been deposited is thermally-treated in step (e) at a temperature between about 100° C. and about 400° C.

19. The process of claim 1, wherein the coating of a promoter metal is applied to the thermally-treated support produced by step (e) before the noble metal coating is applied thereto in step (f).

20. The process of claim 19, wherein the promoter metal is a member selected from the group consisting of iron, nickel, cobalt, manganese, and copper.
